(19) United States
(12) Patent Application Publication
(10) Pub. No.: US 2012/0057371 A1
(43) Pub. Date: Mar. 8, 2012

(54) LAMP AND LIGHTING APPARATUS

(76) Inventors: Makoto Kai, Kyoto (JP); Yoshio Manabe, Osaka (JP); Kenji Takahashi, Osaka (JP); Yasushige Tomiyoshi, Osaka (JP)

(21) Appl. No.: 13/146,444

(22) PCT Filed: Feb. 17, 2011
(86) PCT No.: PCT/JP11/00863

§ 371 Date: Jul. 27, 2011

(30) Foreign Application Priority Data
Apr. 30, 2010 (JP) 2010-105891

(51) Int. Cl. F21V 23/00; F21V 29/00

(52) U.S. Cl. 362/646

(57) ABSTRACT

A lamp capable of suppressing an increase in a temperature of semiconductor light-emitting devices such as LED is provided. The lamp includes an LED module (11) which is a light source, a radiator (14) thermally coupled to the light source, a lighting circuit (13) for turning the lighting source on and is housed in the radiator (14), and a base (12) for supplying power to the lighting circuit (13), and the radiator (14) includes a heat sink (15) covering the lighting circuit (13) and a light source attachment (16) to which the light source is placed. Furthermore, a convex (16b) of an end portion of the light source attachment (16) is fit into a recess (15c) of the heat sink (15).

### TECHNICAL FIELD

The present invention relates to lamps and lighting apparatuses, and particularly relates to a lamp and a lighting apparatus using a semiconductor light-emitting device.

### BACKGROUND ART

In recent years, semiconductor light-emitting devices such as Light-Emitting Diodes (LED) have been attracting attention as a new light source for lamps, since LEDs have higher efficiency and longer product life than incandescent lamps and halogen lamps. Researches and development on LED lamps using LED as light source have been done.

It is known that optical output of LED decreases and the product life becomes shorter as the temperature increases. For this reason, it is necessary for the LED lamps to suppress the increase in the temperature of the LED.

LED lamps aiming for suppressing increased temperature of the LED have been conventionally proposed (Patent Literatures 1, 2, and 3).

FIG. 13 is a cross-sectional view of an LED lamp 80 according to prior art 1 disclosed in Patent Literature 1.

As illustrated in FIG. 13, the LED lamp 80 according to prior art 1 disclosed in Patent Literature 1 includes a light source 811 composed of multiple LED chips, a base 812, a lighting circuit 813 provided between the light source 811 and the base 812, and a metal outer case 814 housing the lighting circuit 813.

The outer case 814 includes a peripheral portion 815 exposed to outside, a light-source attachment 816 integrally formed with the peripheral portion 815, and a recess 814a formed on the inner side of the peripheral portion 815.

The light source 811 is attached on the top surface of the light-source attachment 816. The light source 811 is covered with a translucent cover 817.

On the inner surface of the recess 814a of the outer case 814, an insulating component 818 is formed along the inner surface.

The conventional LED lamp 80 with the configuration described above is capable of efficiently conducting heat generated at the LED chips in the light source 811 to the light source attachment 816 and to the peripheral portion 815, since the outer case 814 including the peripheral portion 815 and the light source attachment 816 that are integrally formed is used. This improves cooling capacity for the light source 811, and suppresses increase in the temperature of the LED chip

Patent Literature 2 discloses a light-bulb shaped LED lamp which is an improved version of the LED lamp 80 disclosed in Patent Literature 1.

The light-bulb shaped LED lamp disclosed in Patent Literature 2 has a heat-conducting resin between the light-source attachment 816 and the light source 811 added to the LED lamp 80 illustrated in FIG. 13. With this structure, even when the high-output LED chip with a high optical output is used, it is possible to suppress the increase in the temperature of the LED chip.

FIG. 14 is an external perspective view of the LED lamp according to prior art 2 disclosed in Patent Literature 3.

As illustrated in FIG. 14, the LED lamp 90 according to prior art 2 disclosed in Patent Literature 3 includes a translucent portion 917 which is a translucent cover over the light source module in which LEDs are mounted, a radiator 915 for dissipating heat generated by the light source module, a driving circuit unit (not illustrated) for driving the light-source module, and a base 912 electrically connected to the driving circuit unit.

The radiator 915 also includes heat dissipating fins 915a and a fixing tube 915b for fixing the heat dissipating fins 915a.

In the LED lamp 90 according to prior art 2 with the structure described above, the heat generated from the light-source module is conducted to the heat dissipating fins 915a, and emitted to the outside air from the heat dissipating fins 915a.

### CITATION LIST

### Patent Literature

[Patent Literature 1] Japanese Unexamined Patent Application Publication No. 2006-313717
[Patent Literature 2] Japanese Unexamined Patent Application Publication No. 2009-037995
[Patent Literature 3] Japanese Unexamined Patent Application Publication No. 2009-004130

### SUMMARY OF INVENTION

### Technical Problem

However, in the LED lamp 80 disclosed in Patent Literatures 1 and 2, the outer case 814 including the peripheral portion 815 and the light source attachment 816 which are integrally formed is used. Thus, the insertion of the lighting circuit 813 into the outer case 814 is limited by the opening area on the base 812 side, which is narrow. This reduces the efficiency of the work for incorporating the lighting circuit 813 into the outer case 814, reducing the workability for assembling lamp.

In addition, in the LED lamp 90 disclosed in Patent Literature 3, thermal convection in the radiator 915 does not effectively occur, and the heat dissipating function of the heat dissipating fins 915a does not function properly. Consequently, there is a problem that the LED lamp 90 disclosed in Patent Literature 3 cannot sufficiently suppress the increase in the temperature of the LED.

The present invention has been conceived as a solution to the problems, and it is an object of the present invention to provide a lamp and a lighting apparatus capable of suppressing the increase in the temperature of semiconductor light-emitting device to prevent a reduction in luminous flux such that a predetermined illuminance can be obtained without decreasing the workability when assembling the lamp.

### Solution to Problem

In order to solve the problems described above, an aspect of the lamp according to the present invention is a lamp including: a light source having a semiconductor light-emitting device; a radiator thermally coupled to the light source; a lighting circuit for turning the lighting source on, the lighting circuit being housed in the radiator; and a base for supplying power to the lighting circuit, in which the radiator includes at least a first heat dissipating component covering the lighting circuit and a second heat dissipating component to which the light source is placed, and an end portion of the second heat dissipating component is fit into a recess or protrusion of the first heat dissipating component.

As described above, the end portion of the second heat dissipating component is fit into the recess or protrusion of the first heat dissipating component. Thus, the contact area of the first heat dissipating component and the second heat dissipating component can be increased. With this, it is possible to improve the heat dissipating capability of the light source can be increased. Furthermore, with this structure, it is possible to attach the first heat dissipating component and the second heat dissipating component more firmly. Furthermore, since the radiator includes more than one component, namely, at least the first heat dissipating component and the second heat dissipating component, it is possible to easily incorporate the lighting circuit into the first heat dissipating component.

Furthermore, in an aspect of the lamp according to the present invention, it is preferable that a portion having a curve is included in at least one of a perpendicular cross-sectional outline of the end portion of the second heat dissipating component and a perpendicular cross-sectional outline, of the recess or protrusion of the first heat dissipating component.

With this, it is possible to attach the first heat dissipating component and the second heat dissipating component even more firmly, and to further increase the contact area of the first heat dissipating component and the second heat dissipating component, thereby further improving the heat dissipating capability of the light source.

Furthermore, in an aspect of the lamp according to the present invention, it is preferable that the curve at the end portion of the second heat dissipating component and the curve at the recess or the protrusion of the first heat dissipating component are substantially semicircular arcs.

With this, it is possible to attach the first heat dissipating component and the second heat dissipating component even more firmly, and to further increase the contact area of the first heat dissipating component and the second heat dissipating component. Furthermore, since the end portion of the second heat dissipating component is an arc, it is possible to reduce the friction resistance between the second heat dissipating component and the first heat dissipating component when attaching the second heat dissipating component to the first heat dissipating component. Thus, it is possible to fit the second heat dissipating component into the first heat dissipating component more easily.

Furthermore, in an aspect of the lamp according to the present invention, it is preferable that the first heat dissipating component includes the recess, and the end portion of the second heat dissipating component is a convex fit into the recess.

With this, since the end portion of the second heat dissipating component is a convex, the friction resistance between the second heat dissipating component and the first heat dissipating component can be reduced further, allowing the second heat dissipating component to be fit into the first heat dissipating component more easily.

Furthermore, in an aspect of the lamp according to the present invention, it is preferable that the first heat dissipating component is a tubular body, the recess of the first heat dissipating component is recessed toward a tubular axis of the first heat dissipating component, and the convex of the second heat dissipating component protrudes toward a side of the first heat dissipating component.

With this, the second heat dissipating component can be attached from the opening side of the first heat dissipating component which is tubular. Thus, it is possible to easily house the lighting circuit into the first heat dissipating component, improving the workability for assembly. Furthermore, with the improvement of the assembly workability, it is possible to improve the accuracy of positioning the lighting circuit. This secures electric insulation of the lighting circuit and the radiator easily.

Furthermore, in an aspect of the lamp according to the present invention; it is preferable that a vertical groove is formed at the convex of the second heat dissipating component, and a protrusion fit into the vertical groove is formed on the first heat dissipating component.

With this, the first heat dissipating component and the second heat dissipating component may be configured with two recess-protrusion fitting structure, namely the protrusion-recess structure at the end portion of the first heat dissipating component and the protrusion-recess structure including the protrusions and the vertical grooves. With this, it is possible to attach the first heat dissipating component and the second heat dissipating component more firmly, and further increase the contact area.

Furthermore, in an aspect of the lamp according to the present invention, it is preferable that part of the second heat dissipating component is capable of elastically deformed.

With this, part of the second heat dissipating component is elastically deformed when attaching the second heat dissipating component to the first heat dissipating component. Thus, it is possible to easily fit the convex of the second heat dissipating component into the recess of the first heat dissipating component.

Furthermore, in an aspect of the lamp according to the present invention, it is preferable that the second heat dissipating component includes a skirt portion extending along an inner circumference of the first heat dissipating component, and a cut is formed in the skirt portion.

With this, when attaching the first heat dissipating component into the second heat dissipating component, the skirt portion of the second heat dissipating component receives a stress from the inner surface of the first heat dissipating component as the second heat dissipating component is inserted into the first heat dissipating component. With this, in the second heat dissipating component, the convex is elastically deformed as the skirt portion is elastically deformed inward. Therefore, it is possible to easily fit the convex of the second heat dissipating component into the recess of the first heat dissipating component.

Furthermore, it is possible to increase the contact area of the first heat dissipating component and the second heat dissipating component. Thus, it is possible to further increase the heat dissipating capability of the light source.

Furthermore, in an aspect of the lamp according to the present invention, it is preferable that the first heat dissipating component includes the protrusion, and the end portion of the second heat dissipating component is a recess fit into the protrusion.

With this, since the first heat dissipating component includes the protrusion, the end portion of the second heat dissipating component is the recess.

Furthermore, in an aspect of the lamp according to the present invention, it is preferable that a second heat dissipating component side of the first heat dissipating component is capable of elastically deformed.

With this, the second heat dissipating component side of the first heat dissipating component is elastically deformed when attaching the second heat dissipating component into the first heat dissipating component, thereby allowing the second heat dissipating component to be easily attached to the first heat dissipating component.

Furthermore, in an aspect of the lamp according to the present invention, a cut is formed in the first heat dissipating component on the second heat dissipating component side.

With this, the elastic deformation of the first heat dissipating component can be easily achieved.

Furthermore, an aspect of the lighting apparatus according to the present invention includes the lamp according to the present invention.

With this, the lighting apparatus including a lamp with high heat dissipating capability can be implemented, and thus it is possible to provide the lighting apparatus with low power consumption.

### Advantageous Effects of Invention

In the lamp and the lighting apparatus according to the present invention, the first heat dissipating component and the second heat dissipating component can be fit into each other with the recess-protrusion structure. Thus, it is possible to increase the contact area of the first heat dissipating component and the second heat dissipating component, improving the heat dissipating capacity of the light source. With this, it is possible to suppress the increase in the temperature of semiconductor light-emitting device so as to prevent a reduction in luminous flux, and a predetermined illuminance can be obtained.

Furthermore, the first heat dissipating component and the second heat dissipating component can be more firmly attached with the recess-protrusion structure. Thus, it is possible to improve the holding capability of the first heat dissipating component and the second heat dissipating component. In addition, since the radiator includes more than one component, namely the first heat dissipating component and the second heat dissipating component. Thus, it is possible to embed the lighting circuit into the first heat dissipating component easily, without reducing the workability at the time of assembling lamp.

### BRIEF DESCRIPTION OF DRAWINGS

FIG. 1 is an exploded perspective view of a lamp according to Embodiment 1 of the present invention.

FIG. 2A is a cross-sectional view of the lamp according to Embodiment 1 of the present invention.

FIG. 2B is an enlarged cross-sectional view of a major part of the lamp according to Embodiment 1 of the present invention (enlarged view of the region A surrounded by the broken line in FIG. 2A).

FIG. 3 is an enlarged perspective view of a radiator of a lamp according to Embodiment 1 of the present invention.

FIG. 4 is an enlarged perspective view of a radiator of a lamp according to Embodiment 1 of the present invention.

FIG. 5 is an enlarged perspective view of a radiator of a lamp according to Embodiment 2 of the present invention.

FIG. 6 is a cross-sectional view of the lamp according to Embodiment 3 of the present invention.

FIG. 7 is an enlarged perspective view of a radiator of a lamp according to Embodiment 3 of the present invention.

FIG. 8 is an enlarged perspective view of a radiator of a lamp according to a variation of Embodiment 3 of the present invention.

FIG. 9A is a cross-sectional view of the lamp according to Embodiment 4 of the present invention.

FIG. 9B is an enlarged cross-sectional view of a major part of the lamp according to Embodiment 4 of the present invention (enlarged view of the region B surrounded by the broken line in FIG. 9A).

FIG. 10 is an enlarged perspective view of a radiator of a lamp according to Embodiment 4 of the present invention.

FIG. 11 is a schematic cross-sectional view of a lighting apparatus according to the present invention.

FIG. 12A is an enlarged cross-sectional view of the radiator of the lamp according to a variation A of the present invention.

FIG. 12B is an enlarged cross-sectional view of the radiator of the lamp according to a variation B of the present invention.

FIG. 12C is an enlarged cross-sectional view of the radiator of the lamp according to a variation C of the present invention.

FIG. 12D is an enlarged cross-sectional view of the radiator of the lamp according to a variation D of the present invention.

FIG. 13 is a cross-sectional view of the LED lamp according to the prior art 1.

FIG. 14 is a cross-sectional view of the LED lamp according to the prior art 2.

### DESCRIPTION OF EMBODIMENTS

The following shall describe a lamp and a lighting apparatus according embodiments of the present invention with reference to the drawings.

### Embodiment 1

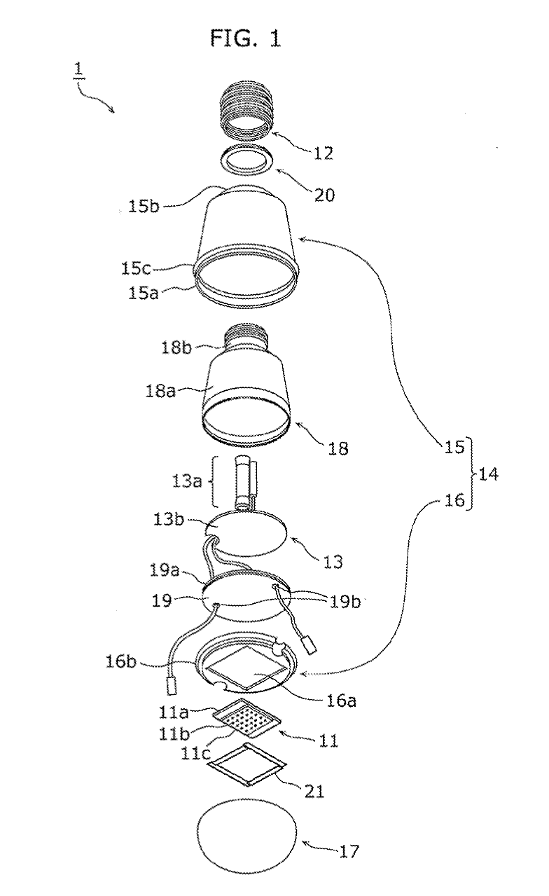

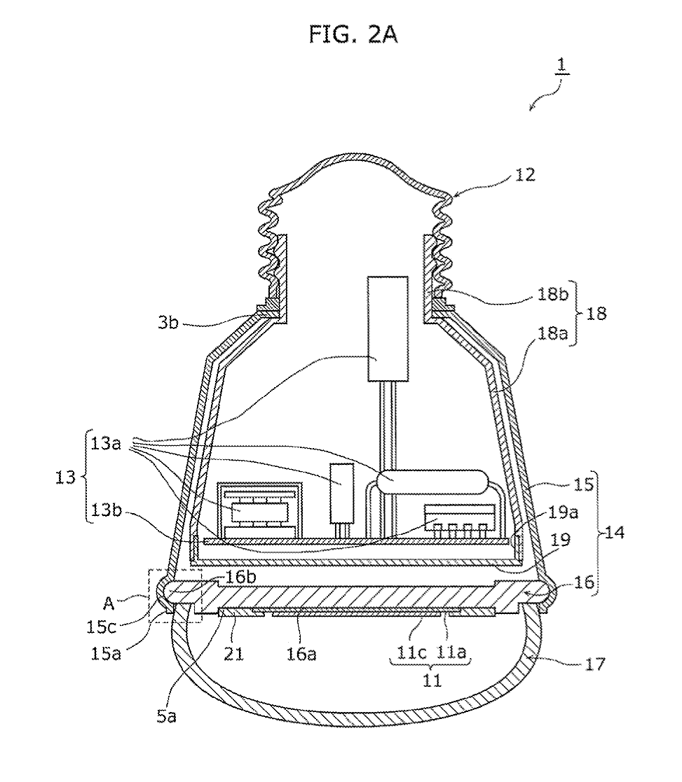

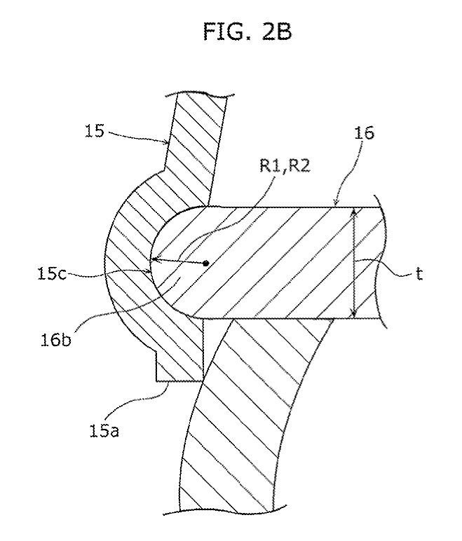

First, a lamp 1 according to Embodiment 1 of the present invention shall be described using FIGS. 2A and 28 with reference to FIG. 1. FIG. 1 is an exploded perspective view of the lamp 1 according to Embodiment 1 of the present invention. FIG. 2A is a cross-sectional view of the lamp 1 according to Embodiment 1 of the present invention. FIG. 2B is an enlarged view of the region A surrounded by the broken lines in FIG. 2A, and is an enlarged cross-sectional view of a major part of the lamp 1 according to Embodiment 1 of the present invention.

As illustrated in FIGS. 1 and 2A, the lamp 1 according to Embodiment 1 of the present invention includes an LED module 11 which is a light source with a semiconductor light-emitting device, a base 12 for receiving power, a lighting circuit 13 for supplying the power received from the base 12 to the LED module 11, arranged between the LED module 11 and the base 12, and a radiator 14 thermally coupled to the LED module 11.

The LED module 11 is a light-emitting module (light-emitting unit) which emits predetermined light. The LED module 11 includes a rectangle ceramic board 11a, LED chips 11b mounted on one side of the ceramic board 11a, and sealing resin 11c for encapsulating the LED chips 11b. Predetermined luminescent particles are dispersed in the sealing resin 11c, and the light emitted from the LED chip 11b is converted to a desirable color by the fluorescent particles.

In this embodiment, blue LEDs which emit blue light are used as the LED chips 11b, and yellow fluorescent particles are used as the fluorescent particles. More specifically, the yellow fluorescent material is excited by the blue light emitted from the blue LED, and emits yellow light, and the yellow light and the blue light from the blue LED are emitted from the LED module 11 as white light. Note that, in this embodiment, approximately 100 LED chips 11b are mounted in a matrix on the ceramic board 11a.

The base 12 is, for example, a screw base such as E26 or E17, and is a power receiving unit for receiving alternating-current (AC) power through two contacts, namely a contact at the top and a contact at the side. The power received by the base 12 is supplied to a power input unit in a circuit board 13b through a lead (not illustrated). Needless to say, a base with other structure used for light bulb-shaped lamp may also be used as the base 12.

The lighting circuit 13 includes circuit devices 13a composing a circuit for lighting the LED chips 11b in the LED module 11, and a circuit board 13b on which the circuit devices 13a are mounted. The lighting circuit 13 is housed in the radiator 14 through a plastic case 18.

Each of the circuit device 13a is composed of multiple components, and converts the AC power received from the base 12 into direct-current (DC) power, and supplies the DC power to the LED chips 11b in the LED module 11. With this, the LED chips 11b emit light.

In this embodiment, the circuit devices 13a include, for example, an electrolytic capacitor (vertical capacitor), a ceramic capacitor (horizontal capacitor), a resistor, a voltage converter configured of a coil, and a semiconductor device such as an intelligent power device (IPD).

The circuit board 13b is a disc-shaped printed-circuit board, and multiple circuit devices 13a are mounted on one side. The circuit board 13b is held by a plastic cap 19 by engaging nails of the plastic cap 19 to be described later.

The radiator 14 is thermally coupled to the LED module, and is a component for dissipating heat generated at the LED module 11. The radiator 14 includes at least two heat dissipating components, and includes a heat sink 15 and a light-source attachment 16 in this embodiment.

The heat sink 15 is a first heat dissipating material according to the present invention, and is arranged to cover the lighting circuit 13. The heat sink 15 is a metal tube case with two openings in the vertical direction, namely a first opening 15a which is an opening on a globe 17 side, and a second opening 15b which is an opening on the base 12 side. The diameter of the first opening 15a is larger than the diameter of the second opening 15b, and the entire heat sink 15 is frusto-conical shaped. The axis of the tubular body of the heat sink 15 (tubular axis) is identical to the axis of the lamp, and the heat sink is a body of revolution with the axis of the lamp as the central axis. Note that, the heat sink 15 is made of aluminum alloy. Alumite treatment is performed on the surface of the heat sink 15 in order to improve thermal emittance.

In this embodiment, near the edge portion of the heat sink 15 on the first opening 15a side, a circular recess 15c is formed on the inner surface of the heat sink 15 at which the light source attachment 16 is attached. The recess 15c is recessed in a direction perpendicular to the tubular axis of the heat sink 15 and is recessed toward outside of the heat sink 15. The recess 15c can be formed by pressing part of the side of the heat sink 15, and both the inner side and the outer side of the heat sink 15 protrudes toward the outside of the heat sink 15. The recess 15c (starting position of the recess 15c) is formed at a position 1 mm to 15 mm away from the end of the heat sink 15 on the first opening 15a side toward the second opening. In other words, at least 1 mm of the edge portion is necessary for sufficiently fitting the light source attachment 16 and for sufficiently fixing the globe 17. Alternatively, the edge portion may be 15 mm or wider, although the wider edge portion reduces the space for the lighting circuit 13.

Note that, the recess 15c is formed by pressing the heat sink 15 such that both the inner and outer sides of the heat sink 15 protrude toward the heat sink 15. However, the present invention is not limited to this example. For example, the outer side of the heat sink 15 may remain flat while the recess may be formed only on the inner side. In this case, the recess may be formed by grinding the inner circumferential surface of the heat sink 15.

The light source attachment 16 is a second heat dissipating component according to the present invention, and is a holder made of a metal board for placing the LED module 11. In this embodiment, the light source attachment 16 is a disc-shaped Aluminum die cast attached to the recess 15 of the heat sink 15. Note that slits for leads connecting the lighting circuit 13 and the LED module 11 are formed in the light source attachment 16.

Furthermore, a recess 16a for placing the LED module 11 is formed in the light source attachment 16. The LED module 11 placed in the recess 16a is clamped by the metal fitting 21.

In this embodiment, the end portion of the light source attachment 16 in contact with the heat sink 15 is referred to as a convex 16b fit in the recess 15c in the heat sink 1′5. The convex 16b protrudes toward the side surface in the inner circumference of the heat sink 15.

As illustrated in FIG. 2A, in the lamp 1 according to this embodiment, the end portion of the light source attachment 16; that is, the convex 16b is fit into the recess 15c of the heat sink 15. More specifically, the convex 16b of the light source attachment 16 is fit into the recess 15c of the heat sink 15. In other words, the dimension of the outer diameter of the light source attachment 16 including the convex 16b is slightly larger than the inner diameter of the portion of the heat sink 15 at which the recess is to be formed (the portion at which the recess 15c is to be formed). Subsequently, the protrusion 15c with a depth acceptable to the convex 16b of the light source attachment 16 may be formed at the portion to which the recess is to be formed. With this, the recess 15c and the convex 16b push each other, and thus, the heat sink 15b and the light source attachment 16 are attached more firmly.

In the lamp 1 according to this embodiment, the perpendicular cross-sectional outline of the recess 15c of the heat sink 15 includes a curve, and the perpendicular cross-sectional outline of the convex 16b in the light source attachment 16 also includes a curve. Note that, the perpendicular cross-section refers to a cross-section cut in a plane including the axis of the lamp, and is the cross-section of the FIGS. 2A and 2B.

In this embodiment, as illustrated in the enlarged view of FIG. 2B, the perpendicular cross-sectional outline of the recess 15c of the heat sink 15 is a substantially semicircular arc, and the perpendicular cross-sectional outline of the convex 16b of the light source attachment 16 is also a substantially semicircular arc. Furthermore, the curved shape of the outline of the recess 15c of the heat sink 15 and the curved shape of the outline of the convex 16b in the light source attachment 16 coincide at a position where the heat sink 15 and the light source attachment 16 contact each other.

As such, in this embodiment, the heat sink 15 and the light source attachment 16 are configured such that the entire inner surface of the recess 15c and the entire outer surface of the convex 16b contact each other in the cross-section of the fitted portion, and are in contact with each other in the almost entire circumference at the fitted portion, with the recess 15c and the convex 16b fitting into each other. In other words, the convex 16b of the light source attachment 16 is configured to fit into the recess 15c of the heat sink 15. With this, it is possible to secure a large contact area of the heat sink 15 and the light source attachment 16 at a predetermined region in the fitted portion, and to make sure the heat sink 15 and the light source attachment 16 to be more firmly attached. Therefore, it is possible to improve heat dissipating capacity for the heat generated by the LED module 11. It is also possible to make the heat sink and the light source attachment to be more securely held.

Note that, in this embodiment, the inner diameter R1 of the recess 15c in the heat sink 15 and the outer diameter R2 of the convex 16b in the light source attachment 16 are 3 mm in radius. The thickness t of the main board of the light source attachment 16 is 6 mm.

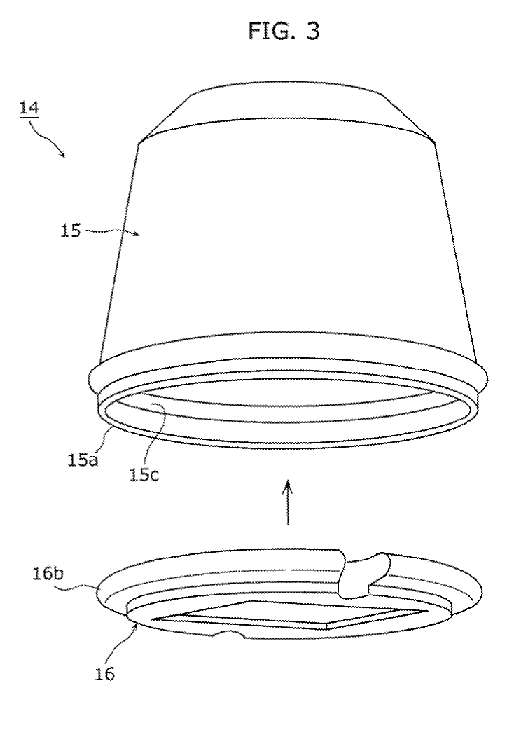

Further description on the recess 15c of the heat sink 15 and the convex 16b of the light source attachment 16 shall be made with reference to FIG. 3. FIG. 3 is an enlarged perspective view of the radiator 14 (the heat sink 15 and the light source attachment 16) in the lamp 1 according to Embodiment 1 of the present invention.

As illustrated in FIG. 3, the recess 15c of the heat sink 15 is formed in a ring shape along the inner circumferential surface of the heat sink 15 on the first opening 15a side. Furthermore, the convex 16b of the light source attachment 16 is formed on the entire end portion on the side of the light source attachment 16.

In the heat sink 15 and the light source attachment 16 with the structure described above, the light source attachment 16 is inserted from the first opening 15a side of the heat sink 15, and the light source attachment 16 is pressed into the heat sink 15. With this, as illustrated in FIG. 2B, it is possible to fit the convex 16b of the light source attachment 16 into the recess 15c of the heat sink 15. As such, the heat sink 15 and the light source attachment 16 are fixed with each other.

Turning back to FIGS. 1 and 2A, the lamp 1 according to Embodiment 1 further includes the globe 17, a plastic case 18, a plastic cap 19, an insulating ring 20, and the metal fitting 21.

The globe 17 is a hemispherical translucent cover for radiating the light emitted from the LED module 11 to outside. The LED module 11 is covered by the globe 17. Optical diffusion treatment such as frosted-glass treatment is performed on the globe 17 to diffuse light emitted from the LED module 11.

The diameter of the glob 17 becomes narrower toward the opening, and the edge of the opening of the globe 17 is placed in contact with the upper surface of the light source attachment 16. The globe 17 is bonded to the heat sink 15 by heat-resistant silicon adhesive.

Note that, the shape of the globe 17 is not limited to hemispherical shape, but may be spheroidal or oblate in shape. Although the globe 17 is made of glass in this embodiment, the material of the globe 17 is not limited to glass. The globe 17 may also be made of synthetic resin.

The plastic case 18 is a case for housing the lighting circuit 13, and includes a tubular first case portion 18a which is substantially identical to the heat sink 15 in shape, and a tubular second case portion 19b which is substantially identical to the base 12 in shape.

The first case portion 18a is placed with a predetermined gap to the heat sink 15. In this embodiment, the gap is provided between the outer circumferential surface of the first case portion 18a and a part of the heat sink 15 opposite to the first case portion 18a.

The second case portion 18b has an opening on the side opposite to the first case portion 18a. The outer circumferential surface of the second case portion 18b is formed in contact with the inner circumferential surface of the base 12. In this embodiment, a screw to be screwed with the base 12 is formed in the outer circumferential surface of the second case portion 18b, and the second case portion 18b contacts with the base 12 via the screw.

In this embodiment, the plastic case 18 may be manufactured by injection molding, and thus the first case portion 18a and the second case portion 18b are integrally molded.

The plastic cap 19 is attached to the opening of the first case portion 18a of the plastic case 18 on the light source attachment 16 side. The light source attachment 16 side of the plastic case 18 is sealed by the plastic cap 19.

The plastic cap 19 is substantially shaped like a circular disc, and a circular protrusion 19a protruding toward the thickness direction of the plastic case is formed at an outer circumferential end portion of the inner surface of the plastic cap 19. Multiple engaging nails (not illustrated) for engaging the circuit board 13b are formed at the inner circumferential surface perpendicular to the protrusion 19a. The protrusion 19a is configured to be fit into the edge of the opening of the first case portion 18a of the plastic case 18. The plastic cap 19 may be formed using the same material as the plastic case 18.

Note that, a through hole 19b for the lead supplying power to the LED module 11 is formed in the plastic cap 19.

The insulating ring 20 is for ensuring insulation between the base 12 and the heat sink 15, and is arranged between the base 12 and the heat sink 15. The inner circumferential surface of the insulating ring 20 is in contact with the outer circumferential surface of the second case portion 18b of the plastic case 18.

The insulating ring 20 is clasped with the end portion of the opening of the base 12 and the end portion of the heat sink 15 by screwing the second case portion 18b of the plastic case 18 and the base 12. Note that, the insulating ring 20 is preferably formed of highly heat conducting resin.

As described above, the lamp 1 according to Embodiment 1 of the present invention has the radiator 14 including the heat sink 15 and the light source attachment 16, and the convex 16b of the light source attachment 16 is fit into the recess 15c of the heat sink 15. Furthermore, the recess 15c of the heat sink 15 and the convex 16b of the light source attachment 16 include a part in which the perpendicular cross-sectional outline is curved.

With this structure, it is possible to increase the dimension of the area in which the heat sink 15 and the light source attachment 16 contact each other, thereby improving the heat dissipating capacity of the LED module 11. Therefore, it is possible to suppress the increase in the temperature of the LED chips 11b in the LED module 11. Furthermore, it is possible to prevent the reduction in the luminous flux from the LED module, obtaining a predetermined illuminance.

In addition, this structure allows the heat sink 15 and the light source attachment 16 to be more firmly attached. Therefore, it is possible to improve the holding function of the heat sink 15 and the light source attachment 16.

The radiator 14 is composed of multiple components. For example, in Embodiment 1, the radiator 14 is composed of the heat sink 15 forming the circumferential side portion, and the light source attachment 16 forming the top. Thus, when inserting the lighting circuit 13 into the inside of the radiator 14 (the plastic case 18), the lighting circuit 13 can be inserted from a side with larger opening area (which is opposite to the base side). This improves workability for assembling the lamp. In addition, in Embodiment 1, the radiator 14 is composed of the tubular heat sink 15 and the tabular light source attachment 16, which facilitates' design for dissipating heat from the circuit devices in the lighting circuit 13. More specifically, with this structure, the circuit board of the lighting circuit 13 may be arranged in the heat sink 15 by inserting the board perpendicularly or horizontally. This provides wider selection on design for transmitting the heat conducted from the circuit device to the circuit board to a component at the periphery of the circuit board, for example.

In addition, the improved workability for the lamp assembly allows the lighting circuit 13 to be more accurately positioned. With this, it is possible to secure electric insulation between the lighting circuit 13 and the radiator 14 even when there is no plastic case 18, improving the reliability of the operation of the lamp.

Furthermore, the heat sink 15 and the light source attachment 16 are fixed with each other by fitting the convex 16b of the light source attachment 16 into the recess 15c of the heat sink 15. Thus, the heat sink 15 and the light source attachment 16 are fixed by increasing the strength of supporting the radiator without using adhesive.

Furthermore, according to the structure of the lamp 1 in Embodiment 1, it is not necessary to rotate the light source attachment 16 when the light source attachment 16 is attached to the heat sink 15. More specifically, the attachment can be performed by placing the convex 16b of the light source attachment 16 in contact with the inner surface of the heat sink 15, and sliding the light source attachment 16 into the heat sink 15, when attaching the light source attachment 16 to the heat sink 15. Accordingly, the lead connecting the LED module 11 and the lighting circuit 13 is arranged through the light source attachment 16, and the lead is housed inside of the lamp without twisting. This prevents malfunction of the lead caused by disconnection, for example.

In addition, the shape of the convex 16b of the light source attachment 16, that is, the perpendicular cross-sectional shape of the convex 16b is circular. This reduces friction resistance between the light source attachment 16 and the heat sink 15 at the time of attachment, facilitating the operation for fitting the light source attachment 16 into the heat sink 15.

### Variation of Embodiment 1

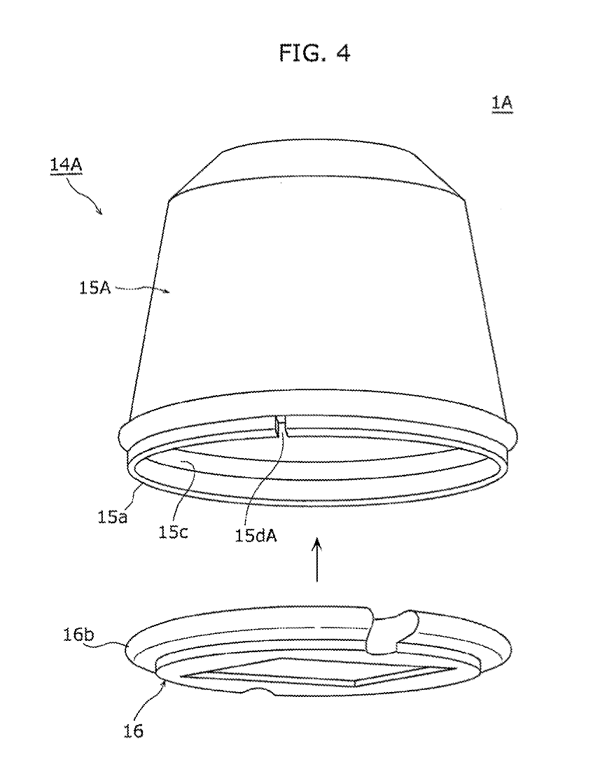

Next, a lamp 1A according to a variation of Embodiment 1 shall be described with reference to FIG. 4. FIG. 4 is an enlarged perspective view of a radiator 14A in the lamp 1A according to the variation of Embodiment 1. Note that, in FIG. 4, the same reference numerals are assigned to components identical to those in FIG. 3, and the description thereof is omitted.

The lamp 1A according to the variation of Embodiment 1 illustrated in FIG. 4 is different from the lamp 1 according to Embodiment 1 of the present invention illustrated in FIG. 3 in the structure of the heat sink 15A comprising the radiator 14A. The rest of the structure is identical to the structure of the lamp 1 according to Embodiment 1.

As illustrated in FIG. 4, in the lamp 1A according to the variation of Embodiment 1, part of the heat sink 15A on the light source attachment 16 side is formed to be capable of elastically deformed. More specifically, in the first opening 15a of the heat sink 15A, a cut 15dA is formed in a vertical direction from the end of the opening of the heat sink 15A. Note that, in this variation, the cut 15dA extends up to a recess 15c of the heat sink 15A.

According to the lamp 1A of the variation of Embodiment 1, when attaching the light source attachment 16 to the heat sink 15A, a stress from inside of the heat sink 15A toward the outside of the heat sink 15A is applied to the heat sink 15A by the light source attachment 16 as the light source attachment 16 is inserted into the heat sink 15A. Here, since the cut 15dA is formed in the heat sink 15A, the first opening 15a side of the heat sink 15A is elastically deformed by the light source attachment 16. Accordingly, the light source attachment 16 can be easily attached to the heat sink 15A.

The cut 15dA can also be used as a mark (alignment mark) for positioning the heat sink 15A and the light source attachment 16. This improves the accuracy when assembling the heat sink 15A and the light source attachment 16.

Note that, although one cut 15dA is provided in this variation, it is not limited to this example. For example, more than one cut 15dA may be formed. In addition, although the cut 15dA in this variation extends up to the recess 15c, it is not limited to this example. For example, the cut 15dA may be formed over the recess 15c. Alternatively, the cut 15dA may be formed not to extend up to the recess 15c. In short, the cut 15dA may be appropriately formed in consideration of the elastic deformation and the strength of the heat sink 15A on the light source attachment 16 side.

Furthermore, although the part of the heat sink 15A on the light source attachment 16 side is formed to be capable of elastically deformed by the cut 15dA, it is not limited to this example. Alternatively, a structure which allows elastic deformation of the part of the heat sink 15A may be adopted appropriately.

Note that, this variation may be applied to the following Embodiments as well.

### Embodiment 2

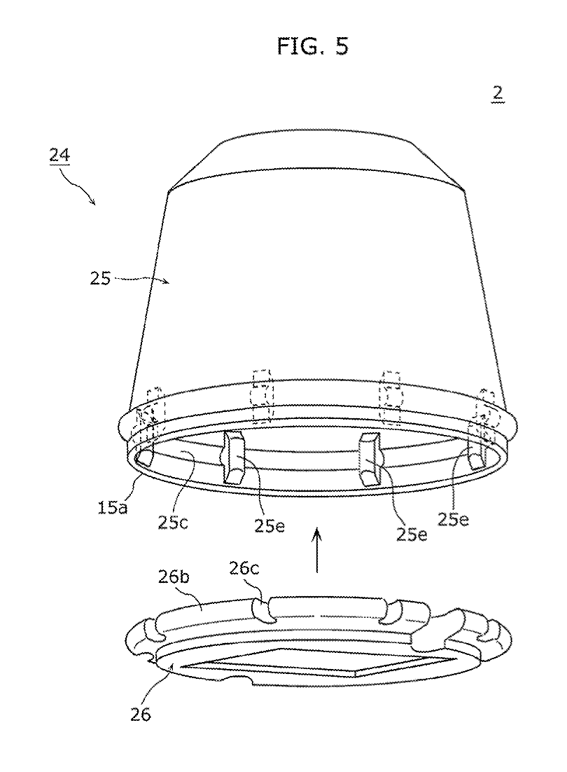

Next, a lamp 2 according to Embodiment 2 shall be described with reference to FIG. 5. FIG. 5 is an external perspective view of a radiator 24 in the lamp 2 according to Embodiment 2 the present invention.

The structure of the radiator 24 in the lamp 2 according to Embodiment 2 of the present invention is different from the lamp 1 according to Embodiment 1 of the present invention. The rest of the structure is identical to the structure of the lamp 1 according to Embodiment 1. Accordingly, the description for the rest of the structure shall be omitted, including the overall structure of the lamp 2. Note that the same reference numerals are assigned to the same components.

As illustrated in FIG. 5, the radiator 24 includes the heat sink 25 and the light source attachment 26, even in the lamp 2 according to Embodiment 2 of the present invention. Note that, the basic structure of the heat sink 25 according to Embodiment 2 is identical to that of the heat sink 15 in Embodiment 1. Accordingly, the description in Embodiment 2 shall be made focusing on the difference. The light source attachment 26 according to Embodiment 2 also has the same base structure as that of the light source attachment 16 according to Embodiment 1. Accordingly, the description in Embodiment 2 shall be made focusing on the difference.

As illustrated in FIG. 5, the heat sink 25 according to Embodiment 2 is the first heat dissipating component according to the present invention, and a recess 25c is formed at the position where the light source attachment 26 is attached, in the same manner as the heat sink 15 according to Embodiment 1. The recess 25c has the same structure as the recess 15c.

The heat sink 25 according to Embodiment 2 further includes protrusions 25e. The protrusions 25e are formed in the inner surface of the edge portion of the first opening 15a of the heat sink 25 in a circumferential direction with a predetermined interval. Each of the protrusions 25e is formed to protrude over the recess 25c toward the center of the heat sink 25. In Embodiment 2, eight protrusions 25e are formed with an equal interval. Note that, in Embodiment 2, since the protrusions 25e are formed, no recess 25c is formed at the parts in which the protrusions 25e are formed.

In addition, as illustrated in FIG. 5, the light source attachment 26 according to Embodiment 2 is the second heat dissipating component according to the present invention, and a convex 26b is formed at a part of the light source attachment 26 in contact with the heat sink 25 in the same manner as the light source attachment 16 according to Embodiment 1. The convex 26b has the same structure as the convex 16b.

The convex 26b composing the side of the light source attachment 26 according to Embodiment 2 further includes vertical grooves 26c. The vertical grooves 26c are fit into the protrusions 25e of the heat sink 15, and are recessed as much as the amount of protrusion of the protrusions 25e. Furthermore, each of the vertical grooves 26c is formed by making a cut in the convex 26b of the light source attachment 26 in the thickness direction. In Embodiment 2, eight vertical grooves 26c are formed to correspond to the protrusions 25e.

Note that, in Embodiment 2, both the inner diameter of the recess 25c of the heat sink 25 and the outer diameter of the convex 26b of the light source attachment 26 are 3 mm in radius. The thickness of the main board of the light source attachment 26 is 6 mm.

The heat sink 25 and the light source attachment 26 with the structure described above are fixed by fitting the convex 26b of the light source attachment 26 into the recess 25c of the heat sink 25, in the same manner as the lamp 1 according to Embodiment 1 of the present invention illustrated in FIGS. 2A and 2B. Here, in Embodiment 2, the light source attachment 26 is fitted into the heat sink 25 by fitting the protrusions 25e of the heat sink 25 into the vertical grooves 26c of the light source attachment 26.

As described above, the lamp 2 according to Embodiment 2 includes the radiator 24 having the heat sink 25 and the light source attachment 26, and the convex 26b of the light source attachment 26 is fit into the recess 25c of the heat sink 25, in the same manner as the lamp 1 according to Embodiment 1. In the lamp 2 according to Embodiment 2, when fitting the convex 26b of the light source attachment 26 and the recess 25c of the heat sink 25, the protrusions 25e of the heat sink 25 are fit into the vertical grooves 26c of the light source attachment 26.

Note that, in Embodiment 2, at the portion where the heat sink 25 and the light source attachment 26 are in contact with each other, the shape of the outline curve of the recess 25c of the heat sink 25 and the shape of the outline curve of the convex 26b of the light source attachment 26 coincide with each other, and the recess 25c of the heat sink 25 is fit into the convex 26b of the light source attachment 26, in the same manner as Embodiment 1.

As described above, the lamp 2 according to Embodiment 2 includes two fitting structure with recess and protrusion in the contact portion of the heat sink 25 and the light source attachment 26, namely the protrusion-recess structure including the recess 25c and the concave 26b, and the protrusion-recess structure including the protrusions 25e and the vertical grooves 26c.

Accordingly, the lamp 2 according to Embodiment 2 can have larger contact area of the heat sink 25 and the light source attachment 26, compared to the lamp 1 according to Embodiment 1 of the present invention. Therefore, it is possible to improve the heat dissipating capacity of the LED module 11. Therefore, it is possible to further suppress the increase in the temperature of the LED chips 11b in the LED module 11. In addition, this structure allows the heat sink 25 and the light source attachment 26 to be more firmly attached. Therefore, it is possible to further improve the holding capability of the heat sink 25 and the light source attachment 26.

Furthermore, in the lamp 2 according to Embodiment 2, configuring the radiator 24 with more than one component, that is, the heat sink 25 which is the side surface and the light source attachment 26 which is the top improves the workability at the time of assembling the lamp by allowing the plastic case 18 in which the lighting circuit 13 is housed to be inserted into the radiator 24 from a side with a larger opening area (the side opposite to the base), in the same manner as Embodiment 1.

In addition, the improved workability for the lamp assembly allows the lighting circuit 13 to be more accurately positioned. With this, it is possible to secure electric insulation between the lighting circuit 13 and the radiator 24 even when there is no plastic case 18, and thereby improving the reliability of the operation of the lamp.

In the lamp 2 according to Embodiment 2, the light source attachment 26 is attached to the heat sink 25 by fitting the protrusions 25e of the heat sink 25 with the vertical grooves 26c of the light source attachment 26. More specifically, the protrusions 25e and the vertical grooves 26c also serve as a guide structure when attaching the light source attachment 26 to the heat sink 25 and a rotation stopper which prevents the rotation of the light source component 26 in the circumferential direction. With this, it is possible to further improve the workability when assembling the heat sink 25 and the light source attachment 26, and further improve the accuracy of positioning the heat sink 25 and the light source attachment 26.

Note that, in the heat sink 25, the protrusions 25e are preferably formed on a side at least toward the first opening 15a from the recess 25c. With this, the protrusions 25e and the vertical grooves 26c may be used as the guide structure.

Furthermore, in Embodiment 2, the heat sink 25 and the light source attachment 26 are fixed by the two protrusion-recess structures. Thus, without adhesive, it is possible to further increase the strength for holding the radiator, and stably fixes the heat sink 25 and the light source attachment 26.

In addition, since the perpendicular cross-section of the concave 26b in the light source attachment 26 is an arc, in the same manner as the lamp 1 according to Embodiment 1 of the present invention, it is possible to reduce the friction resistance between the light source attachment 26 and the heat sink 25, allowing the light source attachment 26 to be easily attached to the heat sink 25.

### Embodiment 3

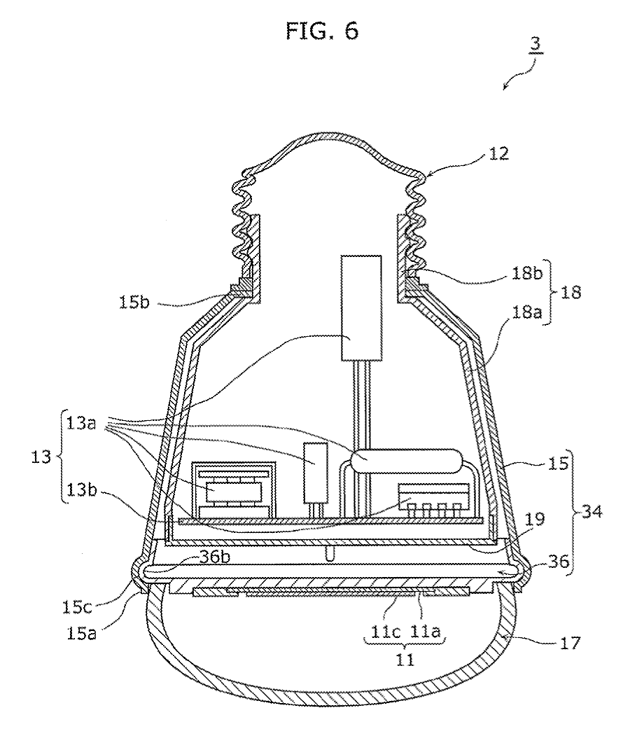

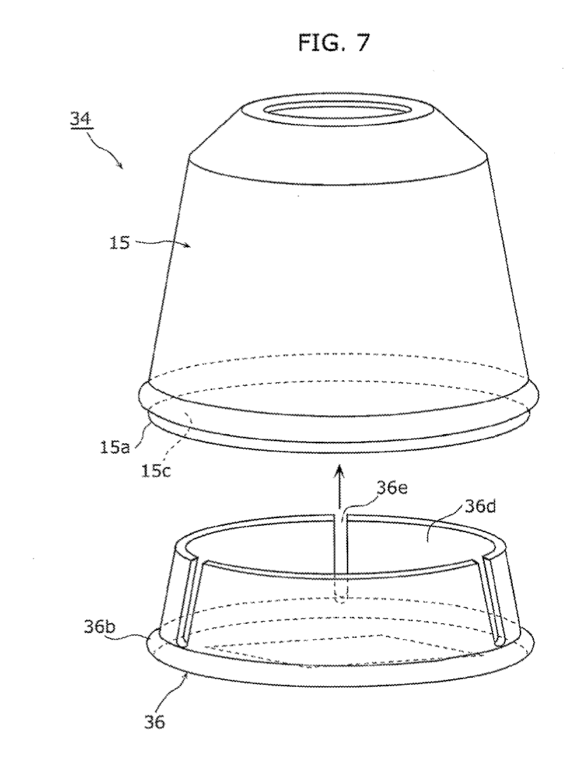

Next, a lamp 3 according to Embodiment 3 shall be described with reference to FIGS. 6 and 7. FIG. 6 is a cross-sectional view of the lamp 3 according to Embodiment 3. FIG. 7 is an enlarged perspective view of a radiator of the lamp 3 according to Embodiment 3.

The structure of the radiator 34, particularly, the structure of the light source attachment 36 in the lamp 3 according to Embodiment 3 of the present invention is different from the lamp 1 according to Embodiment 1 of the present invention. The rest of the structure is identical to the structure of the lamp 1 according to Embodiment 1. Accordingly, the description for the rest of the structure is omitted. Note that the same reference numerals are assigned to the same components.

As illustrated in FIGS. 6 and 7, the lamp 3 according to Embodiment 3 of the present invention includes the radiator 34 having the heat sink 15 and the light source attachment 36. Note that, the heat sink 15 according to Embodiment 3 is the first heat dissipating component according to the present invention, and has the same structure as the heat sink 15 in Embodiment 1. Accordingly, the description for the heat sink 15 is omitted.

In addition, as illustrated in FIG. 7, the light source attachment 36 according to Embodiment 3 is the second heat dissipating component according to the present invention, and a convex 36b is formed at a part in contact with the light source attachment 36, in the same manner as the light source attachment 16 according to Embodiment 1. However, in Embodiment 3, the convex 36b is formed by processing a thin plate, and the inside of the convex 36b is a hollow. This allows the convex 36b to be elastic.

The light source attachment 36 according to Embodiment 3 further includes a skirt portion 36d extending in the vertical direction along the inner circumference of the heat sink 15, as illustrated in FIG. 7. The skirt portion 36d further includes slit-shaped cuts 36e cut along the vertical direction.

In the light source attachment 36 with the structure described above, the skirt portion 36d is elastically deformed by the cut 36e when an external force is applied to the skirt portion 36d, and the convex 36b which is formed continuously with the skirt portion 36d is also elastically deformed as the elastic deformation of the skirt portion 36d.

Note that, in Embodiment 3, the light source attachment 36 may be formed by deep drawing. Furthermore, in Embodiment 3, the outer diameter of the convex 36b in the light source attachment 36 is 3 mm. Furthermore, the height of the convex 36b of the light source attachment 36 is 6 mm. Furthermore, the height of the skirt portion 36d is 10 mm.

The heat sink 15 and the light source attachment 36 with the structure described above are fixed with each other by the convex 36b of the light source attachment 36 fitting into the recess 15c of the heat sink 15 as illustrated in FIG. 6, in the same manner as the lamp 1 according to Embodiment 1 of the present invention illustrated in FIGS. 2A and 2B.

As described above, the lamp 3 according to Embodiment 3 of the present invention includes the radiator 34 having the heat sink 15 and the light source attachment 36, and the convex 36b of the light source attachment 36 is fit into the recess 15c of the heat sink 15, in the same manner as the lamp 1 according to Embodiment 1.

Note that, in Embodiment 3, at the portion where the heat sink 15 and the light source attachment 36 are in contact with each other, the shape of the outline curve of the recess 15c of the heat sink 15 and the shape of the outline curve of the convex 36b of the light source attachment 36 coincide with each other, and the recess 15c of the heat sink 15 is fit into the convex 36b of the light source attachment 36, in the same manner as Embodiment 1.

As described above, in the lamp 3 according to Embodiment 3, the contact portion of the heat sink 15 and the light source attachment 36 have the protrusion-recess fitting, in the same manner as the lamp 1 according to Embodiment 1.

Accordingly, in addition to the increased contact area of the heat sink 15 and the light source attachment 36, the heat sink 15 and the light source attachment 36 can be attached more firmly. In addition, in the lamp 3 according to Embodiment 3, the skirt portion 36d of the light source attachment 36 is fixed in contact with the inner surface of the heat sink 15, and thereby the contact area of the heat sink 15 and the light source attachment 36 can be significantly increased. Accordingly, the lamp 3 according to Embodiment 3 can further improve the heat dissipating capacity of the LED module 11, compared to the lamp 1 according to Embodiment 1.

The lamp 3 according to Embodiment 3, has the radiator 34 composed of more than one component, that is, the heat sink 15 which is the circumferential side and the light source attachment 36 which is the top, in the same manner as Embodiment 1. Thus, when inserting the plastic case 18 housing the lighting circuit 13 into the radiator 34, the plastic case 18 can be inserted from a side with a larger opening area (the side opposite to the base) in the same manner as Embodiment 1, and thus the workability at the time of assembling lamp can be improved.

In addition, the improved workability for the lamp assembly allows the lighting circuit 13 to be more accurately positioned. With this, it is possible to secure electric insulation between the lighting circuit 13 and the radiator 14 even when there is no plastic case 18, and thereby improving the reliability of the operation of the lamp.

Furthermore, when attaching the light source attachment 36 into the heat sink 15, the skirt portion 36d of the light source attachment 36 receives a stress from the inner surface of the heat sink 115 as the light source attachment 36 is inserted into the heat sink 15. With this, as the skirt portion 36d is elastically deformed inward, the convex 36b is also elastically deformed to have an arched shape and decreased outer diameter. This allows the light source attachment 36 to be inserted into the heat sink 15 more easily. As the light source attachment 36 is inserted further, and when the as convex 36b is positioned to the recess 15c, the outer diameter of the light source attachment 36 is restored by the convex 36b fitting into the recess 15c. As such, the fitting is complete. Note that, here, it is preferable that the light source attachment 36 is held by the heat sink 15 with restoring forces of the convex 36b and the skirt portion 36d.

As described above, in Embodiment 3, the convex 36b can be elastically deformed. Thus, it is possible to easily fit the convex 36b of the light source attachment 36 into the recess 15c of the heat sink 15. Therefore, it is possible to set the light source attachment 36 more easily.

In the lamp 3 according to Embodiment 3, the heat sink 15 and the light source attachment 36 can also be fixed by increasing the strength of holding the radiator without adhesive, in the same manner as Embodiments 1 and 2.

In addition, since the perpendicular cross-section of the convex 36b in the light source attachment 36 is an arc, in the same manner as the lamp 1 according to Embodiment 1 of the present invention, it is possible to reduce the friction resistance between the light source attachment 36 and the heat sink 15, and thereby allowing the light source attachment 36 to be easily attached to the heat sink 15.

Note that, in Embodiment 3, three slit-shaped cuts 36e are formed in the skirt portion 36d in the light source attachment 36 as illustrated in FIG. 7. However, the cuts are not limited to three. One or two, or four of more cuts 36e may be provided. The cut 36e may be appropriately formed in consideration of the elastic deformation and the strength of the skirt portion 36d. The shape of the cut 36e may be other than slit.

In addition, in Embodiment 3, a cut from the middle of the cut 36e in the circumferential direction of the skirt portion 36d may also be formed. For example, in the skirt portion 36d interposed between the two cuts 36e, a second cut can be formed from one of the cuts 36e toward the other cut 36e. This increases the elastic force of the skirt portion 36d, facilitating the elastic deformation. This makes the light source attachment 36 to be more easily attached to the heat sink 15.

### Variation of Embodiment 3

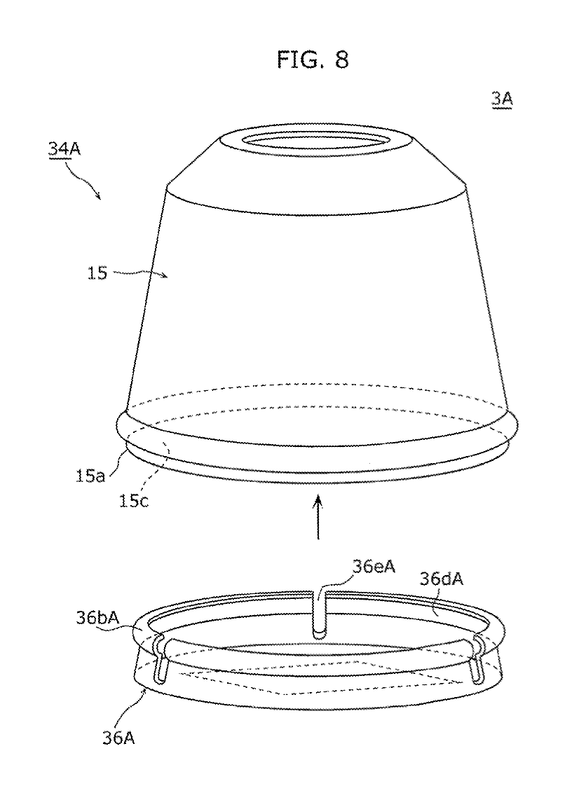

Next, a lamp 3A according to a variation of Embodiment 3 shall be described with reference to FIG. 8. FIG. 8 is an enlarged perspective view of a radiator 34A in the lamp 3A according to the variation of Embodiment 3 of the present invention. Note that, the same reference numerals are assigned to components identical to those in FIG. 7, and the description thereof is omitted in FIG. 8.

The structure of the light source attachment 36A comprising the radiator 34A in the lamp 3A according to the variation of Embodiment 3 illustrated in FIG. 8 is different from the lamp 3 according to Embodiment 3 illustrated in FIG. 7. The rest of the structure is identical to the structure of the lamp 3 according to Embodiment 3.

As illustrated in FIG. 8, the light source attachment 36A in the lamp 3A according to the variation in Embodiment 3 has the convex 36bA which fits into the recess 15c of the heat sink 15 provided at the opening side of the skirt portion 36dA. More specifically, in this variation, the convex 36bA of the light source attachment 36A is formed away from the plane to which the LED module is attached. In this variation, the convex 36bA is formed at a position opposite to the plane to which the LED module is attached.

Furthermore, as illustrated in FIG. 8, the light source attachment 36A according to this variation further includes the skirt portion 36dA in the same manner as the light source attachment 36 illustrated in FIG. 7, and slit-shaped cuts 36eA cut along the vertical direction is formed in the skirt portion 36dA. Note that, in this embodiment, the convex 36bA is also cut by the cut 36eA.

In the light source attachment 36A with the configuration described above, the skirt portion 36dA is elastically deformed by the cuts 36eA when an external force is applied to the skirt portion 36d, in the same manner as the light source attachment 36 illustrated in FIG. 7.

The lamp 3A according to the variation of Embodiment 3 can produce the effect equivalent to the effect achieved by Embodiment 3 of the present invention. More particularly, in this variation, when attaching the light source attachment 36A to the heat sink 15, the perpendicular cross-section of the convex 36bA of the skirt portion 36dA in the light source attachment 36A is an arc. Thus, it is possible to reduce the friction resistance between the light source attachment 36A and the heat sink 15, and thereby allowing the light source attachment 36A to be attached easily to the heat sink 15.

Furthermore, in Embodiment 3, the convex 36bA itself receives the stress. Thus, the convex 36bA is elastically deformed with the side of the LED module attachment surface of the skirt portion 36dA as a supporting point. This facilitates attachment of the light source attachment 36A to the heat sink 15.

Note that, in this variation, the number of the cuts 36eA is not limited to three. Furthermore, a second cut from the cut 36eA along the circumferential direction of the skirt portion 36d may also be formed.

### Embodiment 4

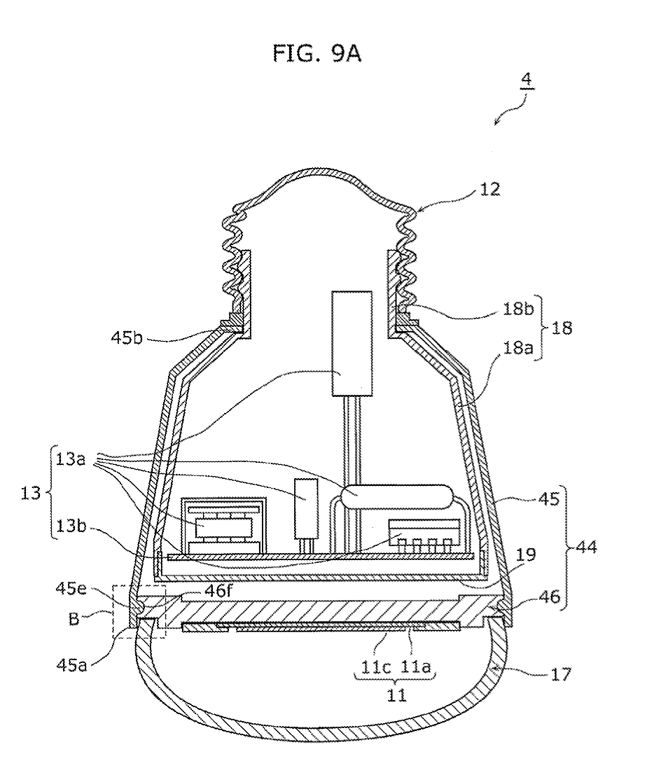

Next, a lamp 4 according to Embodiment 4 shall be described with reference to FIGS. 9A and 9B. FIG. 9A is a cross-sectional view of the lamp 4 according to Embodiment 4 of the present invention. FIG. 9B is an enlarged view of the region B surrounded by the broken lines in FIG. 9A, and is an enlarged cross-sectional view of the major part of the lamp 4 according to Embodiment 4 of the present invention.

The structure of the radiator 44 in the lamp 4 according to Embodiment 4 of the present invention is different from the lamp 1 according to Embodiment 1 of the present invention. The rest of the structure is identical to the structure of the lamp 1 according to Embodiment 1. Accordingly, the description for the rest of the structure is omitted. Note that the same reference numerals are assigned to the same components.

As illustrated in FIG. 9A, the lamp 4 according to Embodiment 4 of the present invention includes the radiator 44 including the heat sink 45 and the light source attachment 46.

The heat sink 45 is a second heat dissipating component according to the present invention, is a metal tubular radiator with two openings in the vertical direction, namely a first opening 45a which is the opening on the globe 17 side and a second opening 45b on the base 12 side. The diameter of the first opening 45a is larger than the diameter of the second opening 45b, and the entire heat sink 45 is frusto-conical shaped. The axis of the tube of the heat sink 45 (tubular axis) is identical to the axis of the lamp, and the heat sink is a body of revolution with the axis of the lamp as the central axis. Note that the heat sink 45 is also made of aluminum alloy in Embodiment 4. Alumite treatment is performed on the surface of the heat sink 45 in order to improve thermal emittance.

In Embodiment 4, a protrusion 45e is formed in the first opening 45a side of the heat sink 45 at a position where the light source attachment 46 is attached. The protrusion 45e is formed to protrude toward the tubular axis of the heat sink 45, that is, the side of the light source attachment 46.

The light source attachment 46 is the first heat dissipating component according to the present invention, and is a holder made of a metal board for placing the LED module 11. The light source attachment 46 is a disc-shaped Aluminum die cast, and is attached to the protrusion 45e of the first opening 45a of the heat sink 45 in Embodiment 4 as well. Note that, the recess 46a for placing the LED module 11 is formed in the light source attachment 46 in the same manner as Embodiment 1.

In this embodiment, the end portion of the light source attachment 46 in contact with the heat sink 45 is referred to as a icy recess 46f. The recess 46f is recessed with respect to the inner circumferential surface of the heat sink 45.

The lamp 4 according to Embodiment 4 is similar to the lamp 1 according to Embodiment 1 of the present invention in that the heat dissipating components comprising the radiator 44 are fit into each other by a recess-protrusion structure. However, the lamp 4 according to Embodiment 4 of the present invention is different from the lamp 1 according to Embodiment 1 in that the recess 46f of the light source attachment 46 (the second heat dissipating component) and the protrusion 45e of the heat sink 45 (the first heat dissipating component) are fit into each other. To put it differently, the lamp 4 according to Embodiment 4 has an opposite recess-protrusion structure from the lamp 1 according to Embodiment 1.

In the lamp 4 according to Embodiment 4, the perpendicular cross-sectional outline of the protrusion 45e in the heat sink 45 is a substantially semicircular arc, and the perpendicular cross-sectional outline of the recess 46f of the light source attachment 46 is also a semicircular arc, as illustrated in the enlarged view in FIG. 9B. Furthermore, the curved shape of the outline of the protrusion 45e in the heat sink 45 and the curved shape of the outline of the recess 46f in the light source attachment 46 coincides at a position where the heat sink 45 and the light source attachment 46 contact with each other. As such, it is possible to increase the contact area between the heat sink 45 and the light source attachment 46, such that the heat sink 45 and the light source attachment 46 are fixed with each other more firmly.

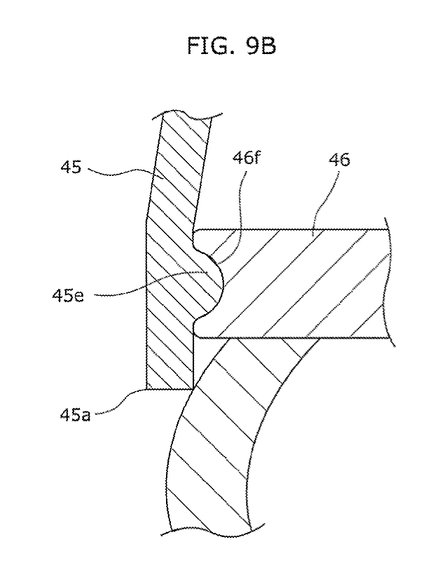

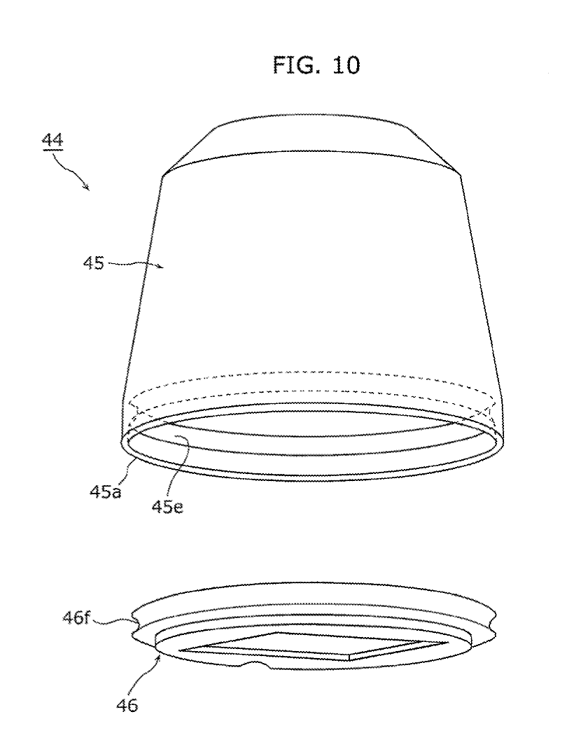

The protrusion 45e of the heat sink 45 and the recess 46f of the light source attachment 46 shall be further described in detail with reference to FIG. 10. FIG. 10 is an enlarged perspective view of the lamp 4 according to Embodiment 4 of the present invention.

As illustrated in FIG. 10, the protrusion 45e of the heat sink 45 is formed to protrude along the inner circumferential surface of the heat sink 45 on the first opening 45a side. Furthermore, the recess 46f of the light source attachment 46 is formed on the entire end portion on the side of the light source attachment 46.

In the heat sink 45 and the light source attachment 46 with the structure described above, the recess 46f of the light source attachment 46 can be fit into the protrusion of the heat sink 45 as illustrated in FIG. 9B, by inserting the light source attachment 46 from the first opening 45a side of the heat sink 45, and pressing the light source attachment 46 into the heat sink 45. As such, the heat sink 45 and the light source attachment 46 are fixed with each other.

The lamp 4 according to Embodiment 4 of the present invention with the structure described above can produce the effects equivalent to the effects achieved by the lamp 1 according to Embodiment 1 of the present invention.

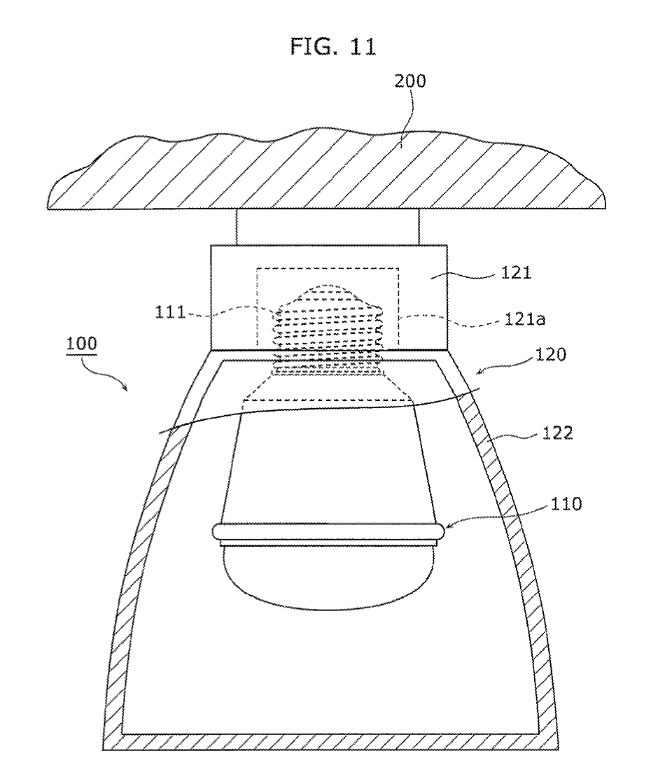

As described above, the description in Embodiments of the present invention focuses particularly on a lamp. However, the lamps according to Embodiments of the present invention are applicable to lighting apparatuses. The following describes a lighting apparatus according to the present invention with reference to FIG. 11. FIG. 11 is a schematic cross-sectional view of a lighting apparatus 100 according to the present invention.

The lighting apparatus 100 according to the present invention is attached to a ceiling 200 in a room when in use, and includes a lamp 110 and a lighting equipment 120, as illustrated in FIG. 11. The lamps according to Embodiments above may be used as the lamp 110.

The lighting equipment 120 is for turning the lamp 110 on and off, and includes an equipment body 121 attached to the ceiling 200 and a lamp cover 122 covering the lamp 110.

The equipment body 121 includes a socket 121a to which a base 111 of the lamp 110 is screwed in, and a predetermined power is supplied to the lamp 110 through the socket 121a.

Note that, the lighting apparatus 100 here is merely an example, and any lighting apparatus including the socket 121a for screwing in the base 111 of the lamp 110 may be used. Furthermore, although the lighting apparatus 100 illustrated in FIG. 11 includes only one lamp, more than one, for example, two or more lamps may also be included.

The lamp and the lighting apparatus according to the present invention have been described above based on Embodiments. However, the present invention is not limited to Embodiments.

For example, in Embodiments, with regard to the radiator, both the first heat dissipating component and the second heat dissipating component are made of metal. However, it is not limited to this example. For example, at least one or all of the heat dissipating components of the radiator may be formed by a heat conducting resin with high thermal conductivity.

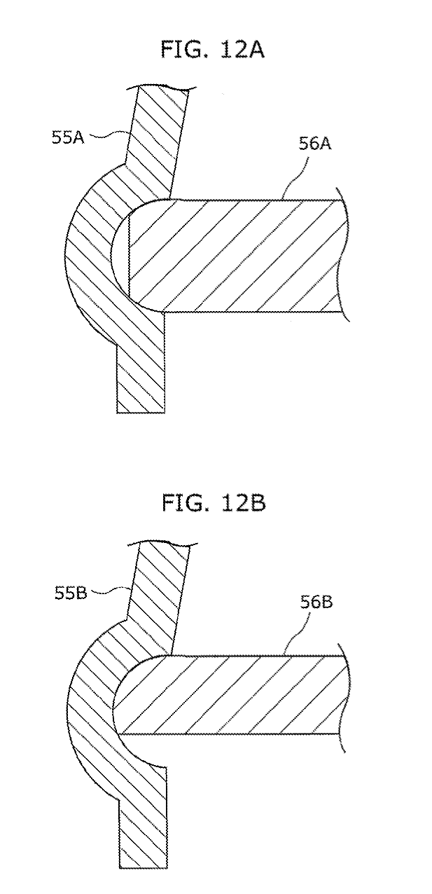

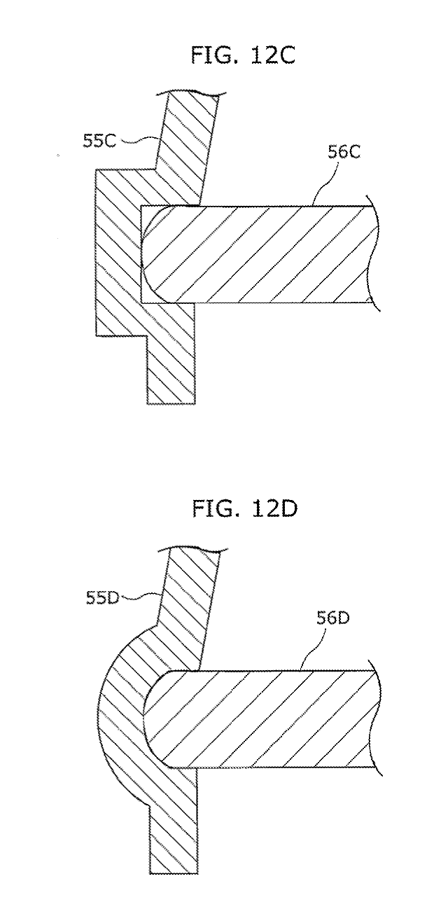

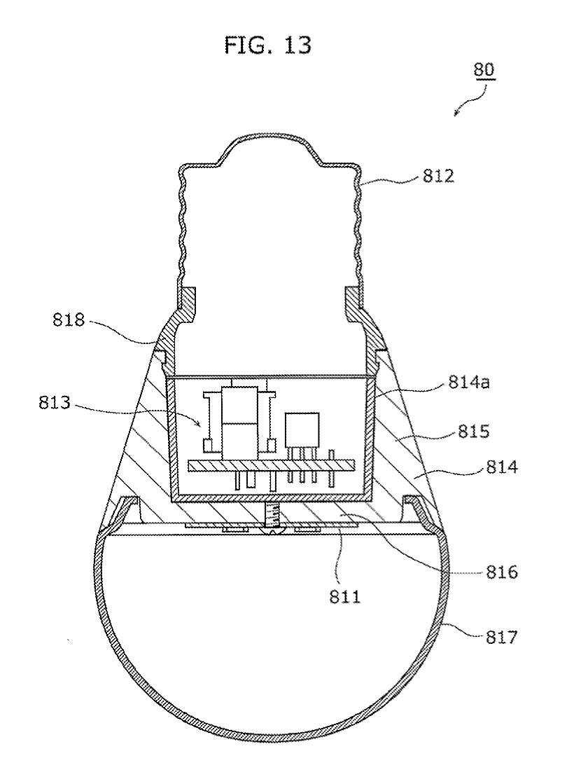

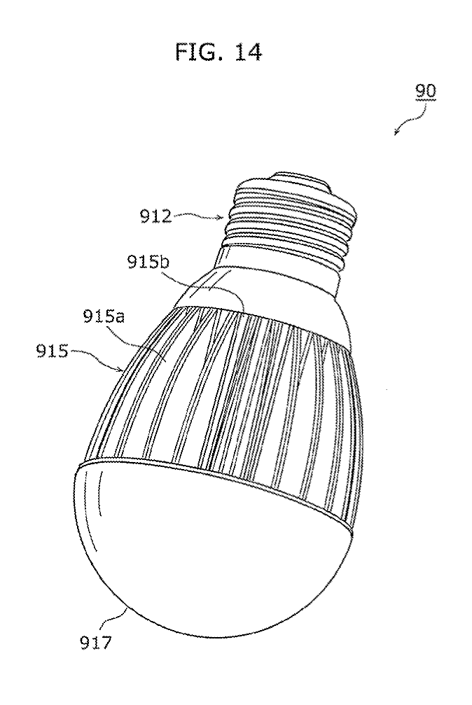

Furthermore, in Embodiments, both the recess of the first heat dissipating component and the convex of the second heat dissipating component are configured to have a curved perpendicular cross-sectional outline. However, it is not limited to this example. At least one of the recess of the first heat dissipating component and the convex of the second heat dissipating component may include a curved perpendicular cross-sectional outline. Furthermore, it is not necessary for the curve at the convex of the second heat dissipating component and the curve at the recess of the first heat dissipating component to coincide with each other. The curve at the recess of the first heat dissipating component and the curve at the convex of the second heat dissipating component may not be a substantially semicircular arc. For example, the structures illustrated in FIGS. 12A to 12D in which the first heat dissipating component is the heat sink and the second heat dissipating component is the light source attachment are possible. FIGS. 12A to 12D are enlarged cross-sectional views of the radiator in the lamps according to variations A and B of the present invention.

As illustrated in FIG. 12A, the heat sink 55A may be identical to the heat sink 15 in Embodiment 1, and the tip of the convex of the light source attachment 56A may include a flat portion. Alternatively, as illustrated in FIG. 12B, the heat sink 55B may be identical to the heat sink 15 in Embodiment 1, and the thickness of the light source attachment 56B can be made thinner to form a part of substantial semicircle with the cross-section of the convex.

In the case of FIGS. 12A and 12B, the heat dissipating effect will be lower than that of Embodiment 1. However, it is possible to make the components more firmly attached and increase the heat dissipating capacity than the conventional examples, by the portion of the cross-sectional curves in contact with each other. Furthermore, it is possible to reduce the friction resistance when attaching the light source attachments 56A and 56B to the heat sinks 55A and 55B, by the cross-sectional curved portion at the light source attachments 56A and 56B.

Alternatively, as illustrated in FIG. 12C, the cross-section of the recess of the heat sink 55C may be rectangular, and the cross-sectional outline of the convex in the light source attachment 56C may include a straight-line portion and a curved portion. In this case, the heat dissipating effect is lower than that of Embodiment 1. However, it is possible to contact the heat sink 55C and the light source attachment 56C with each other via the straight line portion. Thus, it is possible to make the components more firmly attached and to increase the heat dissipating capacity than the conventional examples. Furthermore, the curved portion in the convex of the light source attachment 56C can reduce the friction resistance when attaching the light source attachment 56C to the heat sink 55C.

Furthermore, as illustrated in FIG. 12D, the cross-sectional outline in the recess of the heat sink 55D may include the straight line portion and the curved portion, and the cross-sectional outline of the convex in the light source attachment 56D may include the straight-line portion and the curved portion. In this case, when the sum of the length of the cross-sectional straight line portion and the cross-sectional curved portion is longer than the semi-circle in Embodiment 1, it is possible to improve the heat dissipating capacity, compared to Embodiment 1. It is also possible to make the components more firmly attached. Furthermore, it is also possible to reduce the friction resistance when attaching the light source attachment 56D to the heat sink 55D, by the cross-sectional curve at the convex of the light source attachment 56D.

Furthermore, in Embodiments above, the end portion of the light source attachment is a convex including one convex, a recess including one recess is formed in the inner surface of the heat sink, and the one convex and the one recess are fit into each other. However, it is not limited to this example. For example, a screw portion may be formed by forming a narrow spiral groove at the end portion of the light source attachment, another screw portion may be formed by forming a spiral groove at the inner surface of the heat sink, and the light source attachment and the heat sink may be fit into each other by screwing the screw portions. More specifically, the multiple convexes composing an external screw thread of the screw portion of the light source attachment, and the multiple recesses composing an internal screw thread of the screw portion of the heat sink may be fit into each other. Alternatively, the end portion of the light source attachment may be a convex with one convex, and a screw portion including spiral groove fitting into the convex may be formed on the inner surface of the heat sink, and the light source attachment maybe screwed into the heat sink.

Furthermore, although LEDs (LED chips) are used as the examples in Embodiments, semiconductor laser or organic Electro Luminescence (EL) light-emitting devices may also be used.

The lamps according to Embodiments described above are particularly effective as small light-bulb LED lamps. This is because; the heat dissipating design of the small LED lamp is difficult due to the size and structure.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The present invention is effective for LED lamps and lighting apparatuses having semiconductor light-emitting devices such as LED as light source.

### REFERENCE SIGNS LIST

1, 1A, 2, 3, 3A, 4 Lamp
11 LED module
11a Ceramic board
11b LED chip
11c Sealing resin
12, 111, 812 Base
13 Lighting circuit
13a Circuit device
13b Circuit board
14, 14A, 24, 34, 34A, 44 Radiator
15, 15A, 25, 45, 55A, 55B, 55C, 55D Heat sink
15a First opening
15b Second opening
15c, 25c Recess
15dA Cut
16, 26, 36, 36A, 46, 56A, 56B, 56C, 56D Light source attachment
16a, 814a Recess
16b, 26b Convex
17 Globe
18 Plastic case
18a First case portion
18b Second case portion
19 Plastic cap
19a Protrusion
19b Through-hole
20 Insulating ring
21 Metal fitting
25e Protrusion
26c Vertical groove
36b, 36bA Convex
36d, 36dA Skirt portion
36e, 36eA Cut
45a First opening
45b Second opening
45e Protrusion
46a, 46f Recess
100 Lighting apparatus
110 Lamp
120 Lighting equipment
121 Equipment body
121a Socket
122 Lamp cover
200 Ceiling
80, 90 LED lamp
811 Light source
813 Lighting circuit
814 Outer case
815 Peripheral portion
816 Light source attachment
817 Cover
818 Insulating component
912 Base
915 Radiator
915a Heat dissipating fin
915b Fixing tube
917 Translucent portion

1. A lamp comprising:
a light source having a semiconductor light-emitting device;
a radiator thermally coupled to said light source;
a lighting circuit for turning said lighting source on, said lighting circuit being housed in said radiator; and
a base for supplying power to said lighting circuit,
wherein said radiator includes at least a first heat dissipating component covering said lighting circuit and a second heat dissipating component to which said light source is placed, said second heat dissipating component being detachable and made of metal, and
an end portion of said second heat dissipating component is fit into a recess or protrusion of said first heat dissipating component.

2. The lamp according to claim 1,
wherein a portion having a curve is included in at least one of a perpendicular cross-sectional outline of the end portion of said second heat dissipating component and a perpendicular cross-sectional outline of the recess or protrusion of said first heat dissipating component.

3. The lamp according to claim 2,
wherein the curve at the end portion of the second heat dissipating component and the curve at the recess or the protrusion of the first heat dissipating component are substantially semicircular arcs.

4. The lamp according to claim 1,
wherein said first heat dissipating component includes the recess, and the end portion of said second heat dissipating component is a convex fit into the recess.

5. The lamp according to claim 4,
wherein said first heat dissipating component is a tubular body, the recess of said first heat dissipating component is recessed toward a tubular axis of said first heat dissipating component, and
the convex of said second heat dissipating component protrudes toward a side of said first heat dissipating component.

6. The lamp according to claim 4,
wherein a vertical groove is formed at the convex of said second heat dissipating component, and
a protrusion fit into the vertical groove is formed on said first heat dissipating component.

7. The lamp according to claim 4,
wherein part of said second heat dissipating component is capable of elastically deformed.

8. The lamp according to claim 7,
wherein said second heat dissipating component includes a skirt portion extending along an inner circumference of said first heat dissipating component, and a cut is formed in said skirt portion.

9. The lamp according to claim 1,
wherein said first heat dissipating component includes the protrusion, and the end portion of said second heat dissipating component is a recess fit into the protrusion.

10. The lamp according to claim 4,
wherein a said second heat dissipating component side of said first heat dissipating component is capable of elastically deformed.

11. The lamp according to claim 10,
wherein a cut is formed in said first heat dissipating component on said second heat dissipating component side.

12. A lighting apparatus comprising
the lamp according to claim 1.
